(19) United States
(12) Patent Application Publication
(10) Pub. No.: US 2009/0023118 A1
(43) Pub. Date: Jan. 22, 2009

(54) Mathematical education system

(76) Inventor: Margaret Janes, Mokena, IL (US)

Correspondence Address: McKenna McGovern Burkhart, 134 North LaSalle Street, Suite 2040, CHICAGO, IL, 60602, US

(21) Appl. No.: 11/880,036

(22) Filed: Jul. 19, 2007

(51) Int. Cl. G09B 19/22

(52) U.S. Cl. 434/129; 434/188; 434/201; 434/207

(57) ABSTRACT

An apparatus for teaching mathematical concepts is set forth. The apparatus includes a display. A code for at least one ones number is selected from the group consisting of Arabic numerals 0,1,2,3,4,5,6,7,8,9. At least one non-numeric shape for at least one tens number is selected from sets of numbers, the sets of numbers consisting of 10-19, 20-29, 30-39, 40-49, 50-59, 60-69, 70-79, 80-89, and 90-99. The code and the at least one non-numeric shape are presented in association with one another on the display to form a numerical identity. The numerical identity has a value determined by the code and the at least one non-numeric shape.

### CROSS-REFERENCE TO RELATED APPLICATIONS

None

STATEMENT AS TO RIGHTS TO INVENTIONS MADE UNDER FEDERALLY-SPONSORED RESEARCH AND DEVELOPMENT

None

### FIELD OF THE INVENTION

The present invention relates generally to educational systems, and specifically to a system for teaching and reinforcing mathematical concepts.

### DESCRIPTION OF RELATED ART

Systems of numeracy and mathematical operations have been found to be essential tools for survival in the development of human civilization. These concepts have been employed for trading, purchasing, accounting, storing, building, etc. The history of mathematics contains many fascinating facts about systems of numeracy and governments relying on mathematicians.

Not only was mathematics important in ancient times, but also mastery of mathematical concepts in the modern world is essential to basic survival. Those individuals who do not or cannot master these concepts are considered disabled. The ability to bargain, organize, and account in our modern society that employs a trade system based on numbers and operations of numbers is essential to functioning in modern society.

Further, those able to master difficult concepts in math, going beyond basic operations and fractions, have the ability to become highly trained experts in employing mathematical principles to develop beautiful architecture, mechanical aids for surgeons, medical equipment technology, drugs to treat serious illnesses, vehicles to transport man in space, cell phones, and numerous other practical applications. Clearly, the development of tools and methods to ease and perfect the training of basic mathematics improves our society as a whole.

Historically, most methods of teaching mathematics and tools employed to teach mathematical concepts have included first a mastery of a series of ordinal numbers, typically expressed as Arabic numbers such as 1, 2, 3, . . . 100 or more. A grasp of basic numbers is then followed by mastery of basic mathematical operations, such as addition, subtraction, multiplication, and division, employing the previously learned Arabic numbers. Mastery of these mathematical operations has historically required a certain level of rote memorization. In fact, most teachers have used memorization of results of operations as a method of teaching students answers to mathematical operations. The term students herein includes all individuals working to master a concept, including those needing to be re-taught previously mastered concepts due to illness, injury, loss of vision, or stroke.

Counting can also be employed to successfully teach addition (counting up), subtraction (counting down), multiplication (skipping counting up in groups), and division (skipping counting down in groups). In fact, all of the four basic mathematical operations are simply methods of counting up or down, singly or in groups. Students who can master counting and skip counting can perform all of the basic mathematical operations necessary for survival.

However, not all students are able to master learning Arabic numbers. Some individuals struggle with writing and/or mental mastery of the Arabic number system, whether they are simply intimidated by Arabic numbers, or suffer from a condition such as dyslexia that interferes with the mastery of 2 digit numbers. Other students find Arabic representation boring and monotonous. Many students enjoy learning that includes visual concepts. The concepts of counting and skip counting can be mastered without any knowledge of the formation of the Arabic representation for the answer associated with a particular operation. As a result, these concepts can be taught prior to or in the absence of a mastery of Arabic numerals. Unfortunately, existing teaching methods fail to integrate alternative basic numeracy techniques into the teaching of more advanced mathematical concepts.

It is therefore desirable to provide an improved system for teaching and reinforcing mathematical concepts that eliminates the need to master recognition and/or writing of a large amount of Arabic numbers before instruction directed to basic mathematical operations can be performed.

### SUMMARY

In accordance with the principles of the present invention, an improved systems for teaching and reinforcing mathematical concepts is set forth. The system includes an apparatus for teaching mathematical concepts. The apparatus includes a display. A code for at least one ones number is selected from the group consisting of Arabic numerals 0,1,2,3,4,5,6,7,8,9. At least one non-numeric shape for at least one tens number is selected from sets of numbers, the sets of numbers consisting of 10-19, 20-29, 30-39, 40-49, 50-59, 60-69, 70-79, 80-89, and 90-99. The code and the at least one non-numeric shape are presented in association with one another on the display to form a numerical identity. The numerical identity has a value determined by the code and the at least one non-numeric shape.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates an improved system for teaching and reinforcing mathematical concepts in accordance with the principles of the present invention.

FIG. 2 illustrates an exemplary color code for the improved system for teaching and reinforcing mathematical concepts in accordance with the principles of the present invention.

FIG. 3 illustrates another alternative embodiment of an improved system for teaching and reinforcing mathematical concepts in accordance with the principles of the present invention.

FIG. 4 illustrates an apparatus of an improved system for teaching and reinforcing mathematical concepts in accordance with the principles of the present invention.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

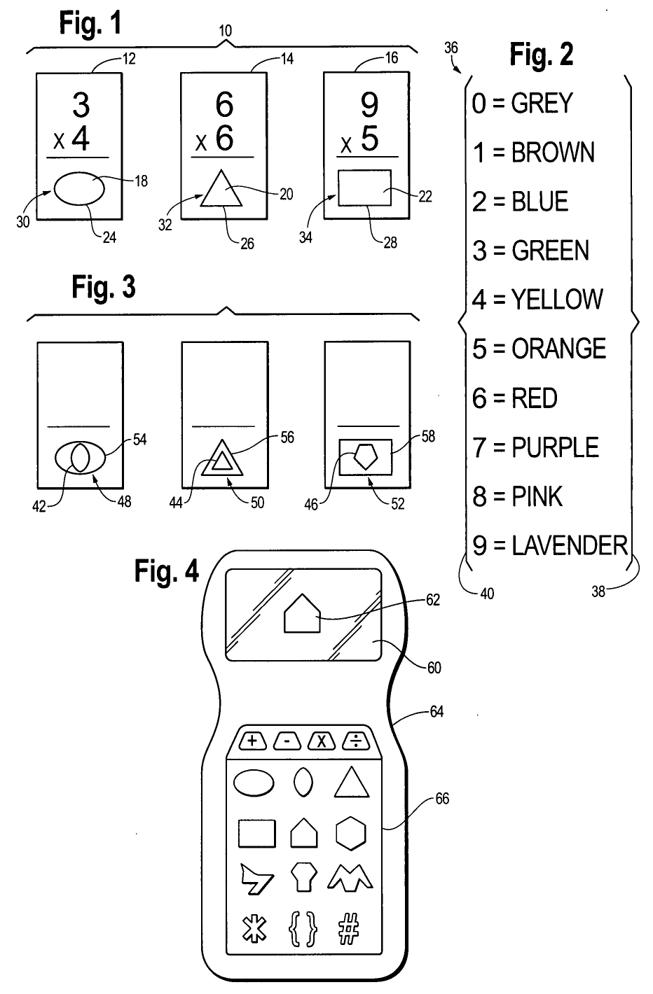

FIG. 1 illustrates an exemplary system for teaching and reinforcing mathematical concepts 10 in accordance with the principles of the present invention. The system 10 includes displays 12,14,16. Codes 18, 20, 22 for at least one ones number selected from the group consisting of Arabic numerals 0,1,2,3,4,5,6,7,8,9 are presented in association with non-numeric shapes 24, 26, 28 for at least one tens number. As illustrated in FIG. 1, the codes 18, 20, 22 can be contained within the shapes 24, 26, 28. Alternatively, the codes 18, 20, 22 could be provided outside the shapes 24, 26, 28 as long as an association between the codes 18, 20, 22 and the shapes 24, 26, 28 can be readily determined. Further, the shapes 24, 26, 28 illustrated in FIG. 1 can take any suitable form, as discussed below.

The at least one tens number represented by the shapes 24, 26, 28 in FIG. 1 is selected from sets of numbers, the sets of numbers consisting of 10-19, 20-29, 30-39, 40-49, 50-59, 60-69, 70-79, 80-89, and 90-99. Codes 18, 20, 22 and the at least one non-numeric shape 24, 26, 28 are presented in association with one another on the displays 12, 14, and 16, respectively, to form numerical identities 30, 32, 34. Each of the numerical identities 30, 32, 34 has a numerical value determined by codes 18, 20, 22 and the non-numeric shapes 24, 26, 28. If the result of a mathematical operation produces a numerical value less than (<) ten (10), then the empty set ({ }) can be used to indicate the number of tens, and can be colored or otherwise coded to indicate a code for the number of ones of the numerical identity.

In a preferred embodiment, the non-numeric shapes 24, 26, 28 each have a number of edges that correspond to the number of tens represented by each of the shapes 24, 26, 28. The codes can be colors representing Arabic numerals, as shown in FIG. 2.

For example, the numerical identity 30 of FIG. 1 has a numerical value of twelve (12), since the code 18 is blue indicating two ones and the shape 24 has one edge indicating one (1) ten. The equation for the numerical value would be one ten (10) plus two ones (2) equals twelve (12), based on the exemplary values for the code 18 and the shape 24.

Similarly, the numerical identity 32 of FIG. 1 has a numerical value of thirty six (36), since the code 20 is red indicating 6 ones and the shape 26 has three edges indicating three (3) tens. The equation for the numerical value would be three tens (30) plus six (6) ones equals thirty six (36), based on the exemplary values for the code 20 and the shape 26.

The numerical identity 34 of FIG. 1 has a numerical value of forty five (45), since the code 22 is orange indicating five (5) ones and the shape 28 has four edges indicating four (4) tens. The equation for the numerical value would be four tens (40) plus five (5) ones equals forty five (45), based on the exemplary values for the code 22 and the shape 28.

As discussed above, codes 18, 20, and 22 illustrated in FIG. 1 can be, for example, a color code 36, as illustrated in FIG. 2. The color code 36 can include a set of colors, such as the exemplary set {grey, brown, blue, green, yellow, orange, red, purple, pink, lavender} 38 having a one to one correspondence with a set of numbers {0, 1, 2, 3, 4, 5, 6, 7, 8, 9} 40.

Alternatively, codes 18, 20, and 22 can be provided in the form of a non-numeric code shapes, such as code shapes 42, 44, and 46 of FIG. 3. Preferably, code shapes 42, 44, 46 each have a number of edges, where the number of edges of each of the code shapes 42, 44, 46 corresponds to the number of ones in a numerical identity 48, 50, 52.

To determine the numerical identity 48 of FIG. 3, for example, code shape 42 has two edges indicating two ones, and the shape 54 has one edge indicating one ten. The equation for the numerical value would be one ten plus two ones equals twelve, based on the exemplary values for the code shape 42 and the shape 54. Similarly, the numerical identities 50 and 52 are thirty three (33) and forty five (45), respectively.

However, one problem that would arise in using such a shape code for the Arabic numeral representing the ones for a given numerical identity would arise when the number ended in zero (0). A solution to this problem would be to apply a meaningful and appropriate shape to indicate a zero value. One such appropriate shape would be an empty set { }, rather than a closed geometric shape.

Alternatively, the code for the Arabic numeral could provide a one to one correspondence between 10 distinct popular cartoon characters and each of the Arabic numerals 0 to 9. The characters could be displayed within the shapes representing the tens units.

As illustrated in FIG. 4, any suitable display, such as a telephone screen 60 can be employed to present a number identity 62 on a display of, for example, a telephone 64. The number identity 62 can display the result of a mathematical operation, a digit of a telephone number, a digit of a personal code, or any other desired display digit. There are numerous possible displays that can include, for example, a monitor, a flashcard, an electronic display, a workbook page, a gaming device display, or any other suitable display where a number identity could be shown.

As illustrated in FIG. 4, the shape code for the Arabic numerals discussed above could be advantageously used on a telephone 64, a calculator, a computer keyboard, or any other suitable input device in order to benefit those with visual impairments, other impairments, or who simply prefer the graphics created in accordance with the principles of the present invention. For example, a keypad of shapes 66 can be provided on the telephone 64 shown in FIG. 4. In an embodiment, the output of the display 60 of the telephone 64 is the number identity 62. In an alternative embodiment, the output of the display 60 of the telephone 64 is an Arabic numeral.

A method of teaching mathematical concepts is also set forth. The method includes the following steps. First, a code for an Arabic numeral is selected from the group consisting of 0,1,2,3,4,5,6,7,8,and 9. Next, a non-numeric shape for a number selected from the group of sets consisting of 10-19, 20-29, 30-39, 40-49, 50-59, 60-69, 70-79, 80-89, and 90-99 is selected. Finally, the code is displayed in association with the non-numeric shape, thereby forming a numerical identity, where a ones value of the numerical identity is defined by the Arabic numeral represented by the code and a tens value of the numerical identity is defined by a number of outer edges of the non-numeric shape.

The method can further include the step of repeating each of the steps one to three until a numerical identity is formed for each number from the group of sets.

The method of can be further defined by displaying the code in association with the non-numeric shape on a monitor screen.

Alternatively, the method can be further defined by displaying the code in association with the non-numeric shape on a telephone screen.

In yet another embodiment, the method can be further defined by displaying the code in association with the non-numeric shape on a handheld gaming device.

In still another embodiment, the method can be further defined by displaying the code in association with the non-numeric shape on a workbook page.

Yet another embodiment of the method includes displaying the code in association with the non-numeric shape on a card.

The method can be further defined by selecting a color code. In an embodiment, the color code is selected from the group consisting of grey, brown, blue, green, yellow, orange, red, purple, pink, and lavender.

An improved method for teaching multiplication tables is also provided. The method includes forming a distinct association between colors and integers by identifying a color code for a set of integers; applying the color code to the set of integers; selecting a pair of integers from the set of integers; multiplying the integers to form a product; and displaying a non-numeric shape to represent a numeric value of the product. The numeric value of the product has a tens value and a ones value, and wherein the ones value is determined the color code and the tens value is determined by a number of edges of the non-numeric shape.

An apparatus for performing mathematical operations is also set forth. The apparatus includes a keypad of shapes. Numerical operation buttons can also be provided on the keypad. The number of edges of each shape, except zero represented by the empty set, corresponds to an associated Arabic numeral. The apparatus further includes a display for displaying an outcome of an operation employing the shapes of the keyboard, or for displaying a telephone number entered via the keyboard. The outcome or the telephone number can be displayed as Arabic numerals, or as shapes corresponding to the associated Arabic numeral. The display can further include indicia identifying a digit as a one, ten, hundred, thousand, ten thousand . . . etc.

It can be seen from the foregoing that the present invention provides advantages in a wide range of applications. While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. An apparatus for teaching mathematical concepts comprising:
a display;
a non-numeric code for at least one ones number selected from the group consisting of Arabic numerals 0,1,2,3,4,5,6,7,8,9;
at least one non-numeric shape for at least one tens number selected from sets of numbers, the sets of numbers consisting of 10-19, 20-29, 30-39, 40-49, 50-59, 60-69, 70-79, 80-89, and 90-99;
wherein the non-numeric code and the at least one non-numeric shape are presented in association with one another on the display to form a numerical identity, and wherein the numerical identity has a value determined by the code and the at least one non-numeric shape.

2. The apparatus as claimed in claim 1, wherein the non-numeric code is a color code wherein the color corresponds to a specific Arabic numeral.

3. The apparatus as claimed in claim 2, wherein the color code is used in conjunction with the Arabic numeral to which the color corresponds.

4. The apparatus as claimed in claim 3, wherein the code for the Arabic numeral 0 is an empty set.

5. The apparatus as claimed in claim 1, wherein the at least one non-numeric shape has a total numbers of edges, the total number of edges being selected from the group consisting of 1, 2, 3, 4, 5, 6, 7, 8, and 9, and wherein the total number of edges corresponds to the number of tens for the value of the numerical identity.

6. The apparatus as claimed in claim 1, wherein the display is a card.

7. The apparatus as claimed in claim 1, wherein the display is a monitor.

8. The apparatus as claimed in claim 1, wherein the display is an electronic display.

9. The apparatus as claimed in claim 1, wherein the display is a workbook page.

10. The apparatus as claimed in claim 1, wherein the display is a telephone screen.

11. The apparatus as claimed in claim 1, wherein the display is a gaming device display.

12. A method of teaching mathematical concepts comprising the following steps:
selecting a non-numeric code for an Arabic numeral selected from the group consisting of 0,1,2,3,4,5,6,7,8,and 9;
selecting a non-numeric shape for a number selected from the group of sets consisting of 10-19, 20-29, 30-39, 40-49, 50-59, 60-69, 70-79, 80-89, and 90-99;
displaying the non-numeric code in association with the non-numeric shape thereby forming a numerical identity, where a ones value of the numerical identity is defined by the Arabic numeral represented by the non-numeric code and a tens value of the numerical identity is defined by a number of outer edges of the non-numeric shape.

13. The method of claim 12, further comprising the step of repeating steps one to three until a numerical identity is formed for each number from the group of sets.

14. The method of claim 12, wherein the step of displaying the code in association with the non-numeric shape is further defined by displaying the code in association with the non-numeric shape on a monitor screen.

15. The method of claim 12, wherein the step of displaying the code in association with the non-numeric shape is further defined by displaying the code in association with the non-numeric shape on a telephone screen.

16. The method of claim 12, wherein the step of displaying the code in association with the non-numeric shape is further defined by displaying the code in association with the non-numeric shape on a handheld gaming device.

17. The method of claim 12, wherein the step of displaying the code in association with the non-numeric shape is further defined by displaying the code in association with the non-numeric shape on a workbook page.

18. The method of claim 12, wherein the step of displaying the code in association with the non-numeric shape is further defined by displaying the code in association with the non-numeric shape on a card.

19. The method of claim 12, wherein the step of selecting a code is further defined by selecting a color code, wherein a color of the color code is selected from the group consisting of grey, brown, blue, green, yellow, orange, red, purple, pink, and lavender.

20. An electronic apparatus comprising:
a keypad of shapes, wherein the number of edges of each of the shapes, except zero represented by the empty set, corresponds to an associated Arabic numeral, said electronic apparatus further comprising:
a display for displaying at least one of an outcome of an mathematical operation performed using the keypad of shapes and a telephone number input into the display via the keypad of shapes.
